(19) United States
(12) Patent Application Publication
(10) Pub. No.: US 2005/0066044 A1
(43) Pub. Date: Mar. 24, 2005

(54) IP-based location service within code division multiple access network

(76) Inventors: Hemant Chaskar, Woburn, MA (US); Jean-Michel Rousseau, San Diego, CA (US); Poornima Lalwaney, San Diego, CA (US)

Correspondence Address: Wayne DeMello;Nokia Inc., 6000 Connection Drive, Irving, TX, 75039, US

(21) Appl. No.: 10/611,053

(22) Filed: Jun. 30, 2003

(51) Int. Cl. G06F 15/16

(52) U.S. Cl. 709/230

(57) ABSTRACT

An Internet protocol (IP) based location system that employs a global positioning system (GPS) component in connection with a position determining entity (PDE) component to determine location of target mobile station(s) via the Internet. As such the system provides an internet protocol based scheme (e.g., UDP) to initiate a location determination session within a CDMA network. The system can provide a location determining service even when the mobile station(s) are not within a home network (e.g., roaming situations). The system can also employ HTTP over TCP/IP so as to facilitate communications between the mobile station(s) and a mobile positioning center (MPC) (e.g., authentication and/or security protocols/schemes). Furthermore, the system can identify a PDE of a plurality of available PDEs that is most suitable for a given state of the mobile station and/or state of the user and/or particular location based application being employed by the mobile station.

### TECHNICAL FIELD

This invention relates generally to cellular systems. More particularly, this invention relates to mobile communication services and devices.

### BACKGROUND OF THE INVENTION

The development and refinement of wireless communication services and devices continues to occur at an extremely rapid pace. Advancements in wireless communication services and devices are mostly based upon consumer demand. In order to fulfill consumer needs, the wireless communications industry provides a plurality of services (e.g., calling plans, billing methods . . . ) and devices (e.g., models of devices having applications, and features). Smaller devices, game applications, web access, phonebook storage, longer battery life, less dropped calls are a few examples that encourage the wireless communication industry to improve upon existing technology.

One response to such demand is development of digital wireless technologies that can accommodate increased network traffic within a limited radio spectrum. For example, technologies such as Global System for Mobile (GSM) employing Time Division Multiple Access (TDMA) were developed, wherein a time-sharing protocol is employed to provide three to four times more capacity than existing analog technologies. In general, TDMA employs a technique wherein a communication channel is divided into sequential time slices. Each user of a channel is provided with a time slice for transmitting and receiving information in a round-robin manner. For example, at any given time “t,” a user is provided access to the channel for a short burst. Then, access switches to another user who is provided with a short burst of time for transmitting and receiving information. The cycle of “taking turns” continues, and eventually each user is provided with multiple transmission and reception bursts.

Shortly after TDMA was introduced, Code Division Multiple Access (CDMA) was developed, and represented an enhanced solution to analog transmission deficiencies. Code Division Multiple Access provides for channel sharing, wherein one or more users can transmit and receive concurrently via employing spread spectrum digital modulation.

In this, a user's stream of bits is encoded and spread across a very wide channel in a pseudo-random fashion. The receiver is designed to recognize and undo the randomization in order to collect the bits for a particular user in a coherent manner. Code Division Multiple Access provides approximately ten times the capacity of the analog technologies, and enables increased voice quality, broader coverage and increased security—today, CDMA is the prevalent technology employed in mobile systems.

Technological advances in the electronics and computer industries, including smaller components, reduced power consumption, and the Internet, for example, have driven the mobile communications industry to further GSM and CDMA technologies, and to explore other technologies. One such improvement includes EDGE (Enhanced Data-Rates for GSM Revolution) technology. The evolution of GSM to EDGE mitigates various issues associated with voice traffic bandwidth and provides higher data throughput, affording for more efficiency and higher performance. For example, EDGE provides for data rates up to 384 Kbps (with a bit-rate up to 69.2 Kbps per timeslot) over broadband. In addition, EDGE provides for more robust services such a Short Message Service (SMS) and Multimedia Message Service (MMS) for messaging, XHTML (including Wireless Application Protocol) browsing, Java applications, FM radio reception, video streaming, and voice and image recording technologies.

Another result of continued efforts to improve mobile communications includes the International Telecommunications Union's adoption of an industry standard for third-generation (3G) wireless systems that can provide high-speed data rates (e.g., for data transmission and Internet use) and new features. Currently, three operating modes (CDMA2000, WCDMA and TD-SCDMA) based on CDMA technology are being developed. CDMA2000 technology provides a relatively simple, quick, and cost effective path to 3G service. CDMA2000 1× technology supports voice and data services over a standard CDMA channel. Additionally, it provides up to twice the capacity (e.g., peak data rates up to 153 kbps and projected peak data rates up to 307 kbps, without compromising voice capacity) of the earlier CDMA networks. The additional capacity accommodates the continuing growth in the wireless Internet market. Moreover, CDMA2000 1× provides longer standby times and is backwards compatible. CDMA2000 1× EV-DO technology provides a data optimized version of CDMA2000 with peak data rates over 2 Mbps and an average throughput of over 700 kbps, which is comparable to DSL and can support video streaming and large file downloads. WCDMA and TD-SCDMA represent more complex enhancements that can entail more costly and complex components, new network designs, and longer verification and validation periods.

One problem associated with wireless communication devices relates to determining a physical location of such a device. Locating a wireless device can be highly desirable for consumers and manufacturers. Consumers benefit from wireless communication device location services with the variety of additional services and applications. Position location service for mobile devices can provide consumers with personnel and asset tracking, directions to restaurants, gas stations, hotels and the like, information services, assets in managing company operations, and/or location-sensitive billing of mobile users enabling more precise rate structure for wireless service providers. On the other hand, the wireless communication manufacturers benefit by fulfilling a Federal mandate for wireless carriers.

The Federal Communications Commission (FCC) required wireless carriers to start providing positioning and/or geolocation of an emergency 911 call from a wireless communication device on Oct. 1, 2001. When an individual calls 911, for emergency assistance, the call is typically passed along by a telecommunications carrier to a local Public Safety Answering Point (PSAP), which is responsible for dispatching police, fire and medical services. For a caller from a landline telephone, the PSAP can precisely identify the caller's location and telephone number even if the caller does not know his or her location. However, there is a dilemma when the caller is a wireless telephone user.

Today, wireless subscribers make a significant number of emergency calls. The PSAPs, however, are unable to pinpoint the location of these callers. Many wireless networks do not provide the PSAP with Automatic Number Identification (ANI) or Automatic Location Identification (ALI). Without the caller's ANI and ALI, the PSAPs have no means for re-establishing contact with these callers or identifying the location of the caller. This is important in case the call is cut off and cannot be reestablished by the caller, or for the PSAP to establish the nearest appropriate emergency facility to send.

In order to provide a wireless communication device location service, Global Positioning Services (GPS) receivers can be incorporated into the wireless communication devices. Once known as Navstar, GPS is a 24 satellite constellation, with each satellite in a 12-hour orbit, 20,200 kilometers above the Earth. The satellites are positioned in six orbital planes with four satellites spaced 60° apart, with a 55° incline with respect to the equatorial plane. A GPS receiver can determine its position on Earth based upon the location of four or more of the GPS satellites and a simple mathematical principle called trilateration.

Many problems arise with conventional GPS receivers. GPS receivers must have a clear view of the skies and signals from the at least four satellites. Thus, GPS receivers do not operate in buildings and other RF-shadowed environments. In addition, GPS can require several minutes to locate a receiver's position without any knowledge of the GPS satellite constellation. Furthermore, GPS receivers bring forth cost, size, power consumption, and/or noise issues when incorporation into wireless communication devices is attempted. Assisted-GPS (A-GPS) technology provides solutions to some problems that arise when using conventional GPS. A-GPS assists the wireless communication device via the network over the air-interface to determine its position or location on Earth. The A-GPS utilizes the wireless network, its own GPS receivers, and estimates of the wireless communications device approximate location based upon cell/sector information to predict the GPS signal the wireless communication device will receive.

The location service for wireless communication is limited to traditional circuit switched architecture using the Signal System 7 Network (hereinafter referred to as “SS7 Network”). However, SS7 is a somewhat arcane and limited architecture that has inherent weaknesses due to its monolithic structure. In view of the above, there is a strong need for providing location services and frameworks within wireless communication devices and networks.

### SUMMARY OF THE INVENTION

The following presents a simplified summary of the invention in order to provide a basis understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention generally relates to an Internet protocol based location determination session providing location service. In accordance with an aspect of the invention, an IP-based location system provides for a terminal and/or network to initiate location determination service via Internet protocols such as for example, but not limited to TCP or UDP.

In accordance with another aspect of the present invention, a location service for a mobile station is provided while in home and/or roaming networks. Within either a terminal or network initiated location service (LCS), a home location register (HLR) residing in the home network enables mobile positioning center (MPC) to determine a serving MPC located in the roaming network. The serving MPC can utilize the mobile station's cell/sector location (e.g., network attachment), thereby assigning a position determining entity (PDE) for location service. Once communication of the PDE information is delivered from the serving MPC to the home MPC (e.g., roaming network to home network), the determined PDE information can be pushed to the mobile station utilizing push architecture or sent as response to earlier query from the mobile station. Upon receiving this message (comprising the PDE information), a location determination session can commence resulting in determination of the location of the mobile station. The location information can then be delivered to a location-based application.

The invention can also employ HTTP over TCP/IP so as to facilitate communications between the mobile station(s) and a mobile positioning center (MPC) (e.g., authentication and/or security protocols/schemes)

In accordance with one exemplary aspect of the invention, the IP-based location system can provide a network-initiated location service. The network-initiated location service allows entities in network, such as application servers, to initiate the location determination session with the use of Internet protocols. A message is generated including information regarding a specific position determining entity (PDE) that a mobile station (e.g., cellular telephone, portable communications device, portable computing device, personal data assistant . . . ) can communicate with using IP (e.g., user datagram protocol or transmission control protocol) to assist the mobile station in determining its location. Depending on a current state of the mobile station and/or user thereof, the invention can determine a most suitable IP protocol (e.g., TCP, UDP . . . ) of a plurality of available protocols to employ for a particular location determination session. The determination can be based for example at least in part on a cost/benefit analysis, PDE implementations, performance issues and/or a probabilistic-based determination as to user preference. Moreover, artificial intelligence based techniques/schemes (e.g., implicitly and/or explicitly trained classifiers) can be employed if desired to facilitate automated determination of the protocol to employ.

In one aspect in accordance with the present invention, the invention can provide for a terminal-initiated location service. The terminal-initiated location service can allow a target mobile station to initiate a location determination session utilizing Internet protocols. The mobile station can send a query to the network requesting PDE information (e.g., IP address, preferred communication method (e.g., TCP or UDP) with associated port number, lifetime for which the PDE would be usable, and/or a temporary session ID and a key to be used in secure message exchanges with PDE). When the PDE information is received by the mobile station, a suitable internet protocol port (e.g., TCP or UDP port) can be opened to initiate a location determination session with a PDE to facilitate identifying location of the mobile station.

In accordance with another aspect of the invention, a mobile station can submit a query relating to a need for an available PDE (e.g., home and/or visited) to establish a connection with regarding location determination. The query can include information (e.g., position quality of service (PQoS), transaction rate, authentication data, server information, type of application the mobile station intends to use, user state, mobile station state, type of mobile station . . . ) that facilitates optimizing the location determination session.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a block diagram of an IP-based location system in accordance with an aspect of the present invention.

FIG. 2 is an exemplary sequence in accordance with an aspect of the present invention.

FIG. 3 is conventional push sequence known in the prior art.

FIG. 4 is an exemplary sequence in accordance with an aspect of the present invention.

FIG. 5 is a block diagram of a system utilizing an IP interface in accordance with an aspect of the present invention.

FIG. 6 is a block diagram of a network-initiated location system in accordance with an aspect of the present invention.

FIG. 7 is a block diagram of a terminal-initiated location system in accordance with an aspect of the present invention.

FIG. 8 is a block diagram of a IP-based location system in accordance with an aspect of the present invention.

FIG. 9 is a block diagram of a WAP system in accordance with an aspect of the present invention.

FIG. 10 is a block diagram of a network-initiated location system in accordance with an aspect of the present invention.

FIG. 11 is a block diagram of a terminal-initiated location system in accordance with an aspect of the present invention.

FIG. 12 is a flow chart illustrating a methodology for a network-initiated system in accordance with an aspect of the present invention.

FIG. 13 is a flow chart illustrating a methodology for a terminal-initiated system in accordance with an aspect of the present invention.

FIG. 14 is a flow chart illustrating a methodology for a IP port initiation in accordance with an aspect of the present invention.

FIG. 15 is a diagram of a network-initiated location system in accordance with an aspect of the present invention

FIG. 16 is diagram of a terminal-initiated location system in accordance with an aspect of the present invention.

FIG. 17 is a schematic block diagram of an exemplary operating environment for a system configured in accordance with the present invention.

FIG. 18 is a schematic block diagram of an exemplary operating environment for a system configured in accordance with the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as described herein.

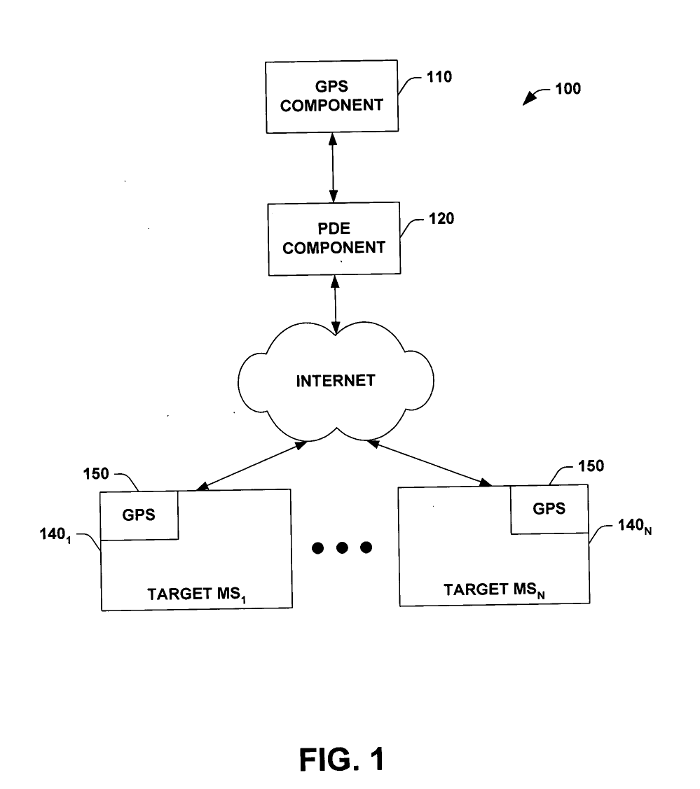

FIG. 1 illustrates an Internet protocol (IP) based location system 100 that employs a global positioning system (GPS) component 110 in connection with a position determining entity (PDE) component 120 to assist in determining location of N number of target mobile station(s) (MS) 140—“N” being an integer—. The MS 140 also contains GPS component 150 that needs to communicate with PDE component 120 for the purposes of location determination positioning. As such the system 100 provides an Internet protocol based scheme (e.g., UDP) to initiate a location determination session within a CDMA network. The system 100 can identify a PDE of a plurality of available PDEs that is most suitable for a given state of the mobile station and/or state of the user and/or particular location based application being employed by the mobile station. A PDE can be identified on factors such as, but not limited to, current and approximate position of the MS (e.g., based on position of current base station it is communicating with), desired PQoS, and/or load sharing. Moreover, the system 100 can determine the most appropriate Internet protocol of a plurality of protocols (e.g., TCP, UDP . . . ) to employ given a subset of the aforementioned states. The mobile station 140 can provide information to facilitate the system 100 optimizing the location determination session via selecting a most appropriate PDE to employ based at least in part on the provided information.

The PDE component 120 maintains position determination assistance data. The PDE component 120 facilitates communication of assistance data to MS 140 as well as obtains position information from MS 140 to assist in location determination. The assistance data and position information via the PDE component 120 provide for geographical position calculation of the mobile station 140. Within the CDMA network, the mobile station 140 can utilize an IP-based protocol to initiate a location determination session with the PDE component 120. The mobile station 140 receives PDE information regarding the PDE component 120—such PDE information can include, for example, IP address, communication method (TCP or UDP), port number, and/or lifetime of the PDE. The mobile station then chooses an IP-based port on its own side to initiate the location determination session over the Internet with the PDE. For example, the IP-based port can be a local TCP or UDP port. The location determination session can be employed to perform transactions in which the location determination is performed. With location service being provided, the mobile station 140 can utilize location-based applications via a CDMA network.

In one aspect in accordance with the present invention, the system 100 can provide a network-initiated location service. The network-initiated location service allows entities in network to initiate the location determination session with the use of Internet protocols. For example, a mobile positioning center (MPC) can determine a PDE that can suitably assist the mobile station 140 in a location determination session. The MPC can create a PDE information message having information regarding a specific PDE which can assist the mobile station 140 in connection with location determination using, for example, A-GPS. Mobile station 140 and PDE can then communicate using IP for location determination message transactions.

The mobile station 140 receives the PDE information message, which includes information to facilitate the mobile station 140 learning about the respective PDE it is or will communicate with. For example, the message can comprise: IP address, preferred communication method (e.g., TCP or UDP) with associated port number, lifetime for which the PDE would be usable, and/or a temporary session ID, and a key to be used in secure message exchanges with PDE. To deliver the PDE information, the system 100 can use for example short message service (SMS) via push proxy gateway (PPG) as specified in wireless application protocol (WAP) push architecture.

The mobile station 140 once receiving the information will have knowledge regarding address of the respective PDE as well as associated parameters required to communicate with the PDE over IP, which in turns provides for assistance in determining the location of the mobile station 140 itself. The mobile station 140 can open a local TCP or UDP port to initiate the location determination session with the PDE. Thereafter, the location determination session can be used for location determination. Accordingly, the subject invention provides for effecting A-GPS within a CDMA network via employment of Internet protocols in lieu of SS7 as in conventional A-GPS systems.

For example, a fleet manager can locate a mobile station 140. The fleet manager application can initiate the system 100 to locate the user with the mobile station 140. The application can request location, in which the request is communicated through a gateway MPC. The MPC can then determine a PDE that would assist the mobile station 140 for location determination. The MPC can create a message for the mobile station 140 with the PDE information. Upon receiving the PDE information message, the mobile station 140 utilizes the message to begin an IP-based location determination session. The session is opened via a IP port to allow location determination of the mobile station 140. The location determined can be conveyed to fleet manager application.

In accordance with another aspect of the invention, the system 100 can provide for a terminal-initiated location service. The terminal-initiated location service allows a mobile station 140 (e.g., terminal) to initiate the location determination session utilizing Internet protocols (e.g., TCP or UDP). The mobile station 140 (e.g., a terminal) can send a query requesting PDE information to determine location of itself. Based upon the query, the mobile station 140 can receive the PDE information, and use this information to open an IP port so as to initiate the location determination session with the respective PDE corresponding to the information. For example, the mobile station 140 can utilize a location-based application such as a map application to determine its location. A user employing the mobile station 140 and map application can initiate the system 100 and send a query to discover a PDE which can assist with location determination session to facilitate the user determining his/her location. The system 100 can infer and/or determine which PDE of a plurality of available PDEs is most suitable to recommend to the mobile station given a variety of state conditions noted supra and/or other extrinsic information (e.g., weather, traffic, bandwidth, time of day, day of week, user preferences, user profile . . . ).

The IP-based system 100 responds by sending the PDE information message. The PDE information message can contain, for example, IP address, port address, lifetime for PDE use, and/or session ID). Target MS 140 receives the PDE information message and initiates the location determination session via Internet protocols such as, TCP or UDP. For example, the target MS 140 can then perform the location determination transactions in order to determine the location for the map application. Thus, the positioning aspects of the A-GPS network can be utilized via Internet protocols for location-based applications within the CDMA network.

It is to be appreciated that any suitable scheme for effecting the query and response can be employed. For example, the system 100 can provide a terminal-initiated location service utilizing HTTP methods. The query may contain data such as PQoS, transaction rate, authentication data etc. and can be conveyed using for example HTTP POST method. The response contains PDE information. The data in query and response can be encoded via any suitable manner (e.g., as an XML or WBXML) document). Query data can be stored so as to enable statistical analysis being performed in connection with historical queries. For instance, a classifier in accordance with the subject invention can be trained using the historical query information to facilitate training the classifier to provide a high probability of success decision regarding satisfying a mobile station's current location determination needs. Thus, the present invention can utilize artificial intelligence (AI) techniques (e.g., Bayesian learning methods that perform analysis over alternative dependent structures and apply a score, Bayesian classifiers and other statistical classifiers, including decision tree learning methods, support vector machines, linear and non-linear regression and/or neural network representation) to facilitate locating a PDE that can assist the mobile station 140 within A-GPS, and/or to facilitate the mobile station 140 locating a trusted network service to send a query. Moreover, AI can be employed to facilitate routing of data packets.

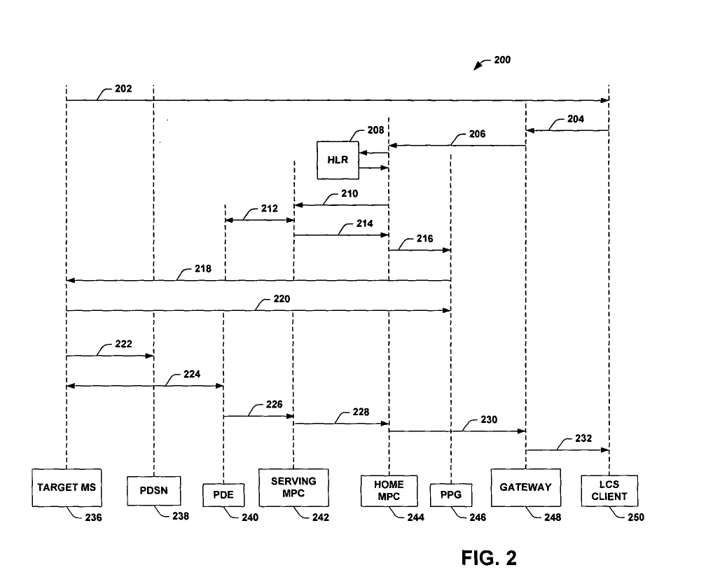

Referring to FIG. 2, an exemplary sequence 200 in accordance with one aspect of the present invention is illustrated. The sequence 200 displays a network-initiated LCS system enabling a LCS client 250 in a network to trigger location service in cellular network. At 202, the LCS client 250 is triggered, for example, via a user associated with a target mobile station (MS) 236 selecting a link and/or button on a displayed web page (e.g., within a browser). In another embodiment, LCS client 250 can be triggered by another entity in the network, for example, a fleet manager application. At 204, the triggered LCS client 250 communicates using mobile location protocol (MLP) to a gateway 248. For example, the MLP has been developed by a location interoperability forum (LIF) and it runs over HTTP/TCP/IP. A location request is forwarded from a gateway 248 to a home MPC 244. Gateway 248 can facilitate mapping between the mobile station's identity, such as for example MDN (mobile directory number), and the identity of the home network. The home MPC 244 resides within a home network (e.g., a network area that service is based) of the target MS 236. When the home MPC 244 is forwarded the location request, the HLR 208 within the home network enables the home MPC 244 to discover identity of a serving MPC 242.

Upon determining identity of the serving MPC 242, the home MPC 244 forwards the location request to the serving MPC 242 (See FIG. 2, 210) which provides an assignment of a PDE 240 (See FIG. 2, 212). The present invention facilitates providing location service while the target MS 236 is roaming (e.g., not within a home network) via forwarding the location request to the serving MPC. Assigning and seeding of the PDE 240 can be done prior to delivering the PDE information to the target MS 236. At 214, the serving MPC 242 provides the PDE information to the home MPC 244 (e.g., roaming network to home network).

In order to provide the target MS 236 with the PDE information, the home MPC 244 can utilize a push proxy gateway (PPG) 246 wherein the home MPC 244 requests the PDE information to be pushed to the target MS 236. For example, home MPC 244 and the PPG 246 can utilize push access protocol (PAP) defined in WAP push framework for communication between them. Thus, the PAP can operate over HTTP or simple mail transfer protocol (SMTP). At 216, the push request has been initiated and the message can be pushed to the target MS 236. For example, the subject invention can utilize connectionless push (SMS) or connection-oriented push as defined in a WAP push framework. It is to be noted that HTTP is advantageous in authentication and security in comparison to other protocols that which will be discussed below.

Continuing at 218, the pushed message is received by the target MS 236 in which a plurality of acknowledgement and/or permission options can be employed. For example, the target MS 236 can utilize pop-access control such that a user must give permission for the LCS client 250 to receive mobile station's location information. In accordance with another aspect of the present invention, the target MS 236 can provide a push acknowledgment 220 to the PPG 246.

Upon the target MS 236 receiving the pushed message with PDE information, location determination messaging session 224 can be initiated with the PDE 240. In accordance with yet another aspect of the present invention, the messaging session can be a user datagram protocol (UDP). In order to utilize the UDP, the target MS provides packet filter information (e.g., traffic flow template or TFT) to a packet data support node PDSN) 238, thereby opening a firewall. For example, the packet filter information can be, but is not limited to, target MS 236 IP address and UDP port number, PDE's IP address and UDP port number. At 222, the target MS 236 requests the PDSN to enable satisfying packets to pass through the firewall provided that the PDSN acknowledges the request. Once the firewall is open, the location determination session via UDP can initiate.

The location determination messaging session 224 with the PDE 240 for the target MS 236 can forward the location (at 226) to the serving MPC 242. In addition, the location determination session 224 can employ location response, and/or usage records from the serving MPC 242 to the home MPC 244 (e.g., providing location service while the target MS 236 is in roaming as seen at 228). At 230, the home MPC 244 can provide location response to the gateway 248, thereby facilitating reception of the MLP response at 232 by the LCS client 250.

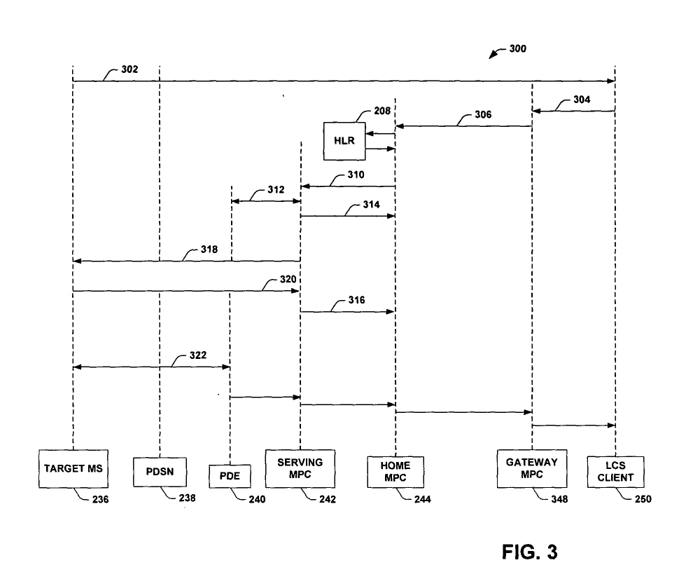

FIG. 3 illustrates a conventional push sequence 300. As discussed supra, the LCS client is triggered at 302 by the target MS 236 which provides a MLP location request at 304. At 306 the location request received by a gateway MPC 348 is forwarded to the home MPC 244, wherein the MPC 244 consults the HLR 208 that identifies the serving MPC 242.

Upon receiving the location request, the serving MPC assigns a PDE 240 to assist in location determination as illustrated at 312. At 318, conventional systems typically utilize a push message over SMS from the serving MPC 242 to the target MS 236. Once the push message is received, conventional systems and/or methodologies provide acknowledgement to the serving MPC 242 and/or status to the home MPC 244. With the push message containing the PDE information received by the target MS 236, the location determination message initiation 322 can begin employing location service.

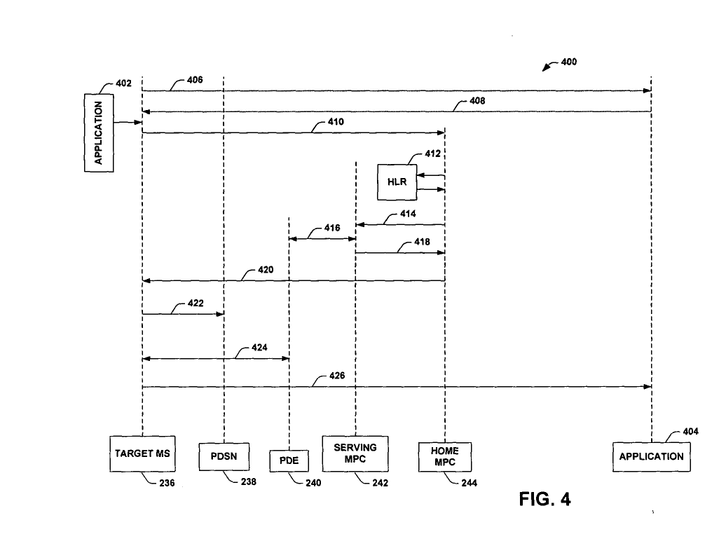

Referring to FIG. 4, an exemplary sequence 400 in accordance with one aspect of the present invention illustrates a terminal-initiated LCS system enabling a target MS 236 to initiate a location service in cellular network. It is to be respected that the location-based application can be comprised by the target MS 236 and/or a remote location as depicted by 402 and 404 respectively. At 406, the location-based application is accessed (e.g., HTTP GET request/response and POST) which allows the application (e.g., at a remote location) to return a WAP location invocation document to the target MS 236 as depicted at 408. At 410, a discovery request is delivered to the home MPC 244 from the target MS 236. For example, HTTP over TCP/IP can be utilized while employing request/response semantics and authentication provision between target mobile station 236 and home MPC 244.

At 412, the home MPC 244 utilizes information from the HLR 412 to discover the serving MPC 242. In roaming instances, the home MPC 244 can forward the request (as seen at 414) to the serving MPC 242 and receive the PDE information at 418 after the PDE 240 has been selected (as seen at 416). Once the PDE information is received by the home MPC 244, a discovery response 420 can be relayed to the target MS 236, thereby enabling initiation of an location determination messaging session 424. In accordance with one aspect of the present invention, the target MS 236 can utilize UDP for the location determination messaging session 424. For security reasons, the target MS 236 can transmit packet filter information to a PDSN 238 in order to open the firewall providing a secure location determination messaging session 424. At 426, the WAP location delivery document can be communicated to the application in which location service can be provided.

In accordance with one aspect of the present invention, the use of HTTP over TCP/IP can be advantageous regarding the security of message transfer between the home MPC and the target MS (See 410 and 420) because of authentication and request/response semantics provisions in HTTP. For example, security components such as public keys, passwords and trusted certificates can be provided to establish a trust between network-based component (home MPC) and target MS. This can include employment of such security components as an Internet Key Exchange (IKE), Internet Protocol Security (IPSEC), Kerberos, one or more security policies, Secure Socket Layers (SSL) and/or other security components in order to limit data access by non-trusted parties. Encryption technologies can be employed in establishing trust relationships, mitigating unwanted data access of private data, and encapsulating control data within a security packet. Target MS' communicating via networks can be configured in accordance with one or more desired levels of security and/or security layers. Security layers can be selected in various combinations with respective layers having one or more associated security components. Data access can be stringently or generously permitted (or there between if desired) according to the selected security layer, layer combination, and/or security components associated with respective layers.

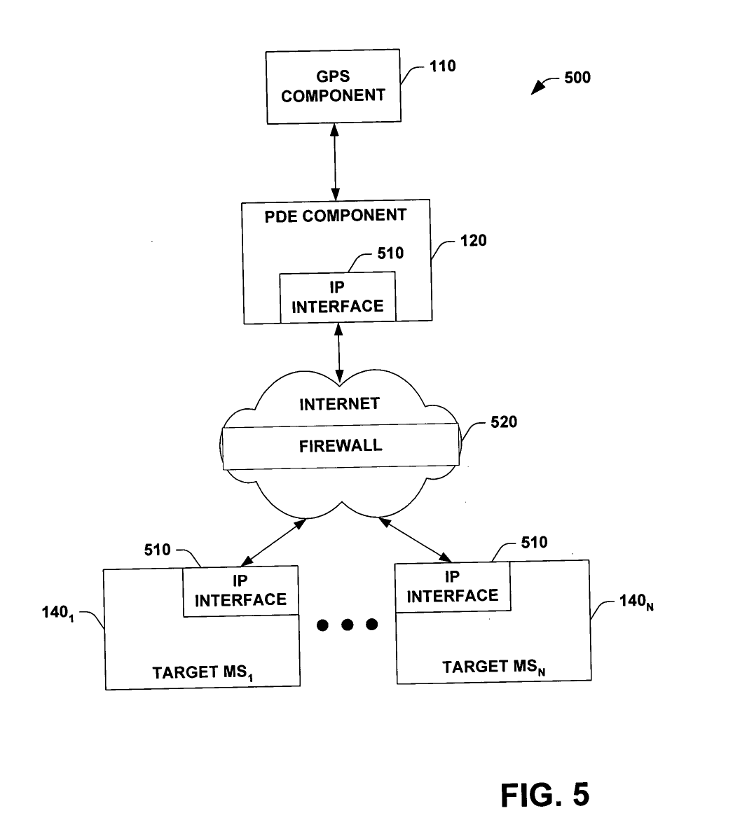

Turning now to FIG. 5, a system 500 is depicted that allows an IP interface 510 to provide an interface for location determination sessions over the Internet. The IP interface 510 can be incorporated in the PDE component 120 and the mobile station 140 to allow location determination positioning assistance. As supra, TCP or UDP ports (which represent transport layer identifiers) can be employed for establishing communication between the PDE 120 and the MS 140. TCP provides a connection-oriented protocol wherein a connection is established and maintained until a message is transmitted and received. Thus, when the mobile station 140 is employed to transmit a message, a TCP connection between the PDE component 120 and the mobile station 140 is opened. The ports at PDE and MS can be dedicated to message transmission.

After obtaining the PDE's IP address and destination port information, the mobile station 140 transmits the message to the destination PDE's IP address and port. Typically, TCP is employed with the Internet protocol wherein a message is transmitted in the form of message units or packets, which facilitate high-speed, efficient routing. When employing TCP/IP, the TCP layer typically tracks data transmission whereas the IP layer handles the routing of packets that contain TCP data as payload. Furthermore, TCP includes support for guaranteed delivery in which the recipient acknowledges the sender when a data payload in packet is received. In addition, TCP allows the sender to wait and retry when the receiver does not respond in a timely manner. TCP provides a reliable Internet protocol allowing the recipient to acknowledge the sender of data transmission within a timely manner. On the other hand, TCP reliability features can be expensive based upon overhead and execution time. Further, there is overhead of establishing connection between the ports prior to actual message transmission.

Another transport protocol available in Internet protocol route is UDP (User Datagram Protocol), which is layered on top of a base Internet protocol and allows the message to be transmitted via the UDP port. The mobile station 140 and PDE communicate by sending data over UDP transport enabling the location determination session. TCP provides a reliable Internet protocol, whereas UDP is faster as it does not involve Internet transport layer message exchanges for connection setup. As the only reliability protection, UDP provides a checksums encoding of the datagram data which is calculated by the sender and later by the receiver. Checksums determine whether calculations of the binary data from the sender match the binary data to the receiver. The checksum is optional, yet performance and security are the trade-off. The subject invention provides for dynamic selection of an optimal protocol (e.g., TCP, UDP, . . . ) based on a utility analysis. In UDP, there is no overhead of connection establishment between ports prior to message transactions. When UDP is used, it is preferable to include identity of location determination session in each UDP packet. The temporary session identity received as part of PDE information message can be used for this purpose.

In order to provide more security, the system 500 can open a firewall 520 which may exist (over the Internet) between the mobile station 140 and the PDE component 120. To open the firewall 520, the mobile station 140 can provide packet filter information to the firewall 520. The packet filter information (e.g., traffic flow template (TFT)) can be, for example, its own IP address and UDP port number, and/or the PDE's IP address and UDP port number. Once received, the firewall 520 can be instructed to open allowing the packets to pass if the packets (e.g., header information) satisfy certain parameter values. After the firewall 520 acknowledges the installation and activation of the packet filter, the IP address and transport port to be used for the Mobile station to PDE communication are opened at the firewall 520, thereby allowing the mobile station 140 to communicate with the PDE component to enable location service for the mobile station 140. In one preferred embodiment, the firewall 520 is located at the PDSN (Packet Data Support Node), which is a gateway between the Internet and CDMA radio network.

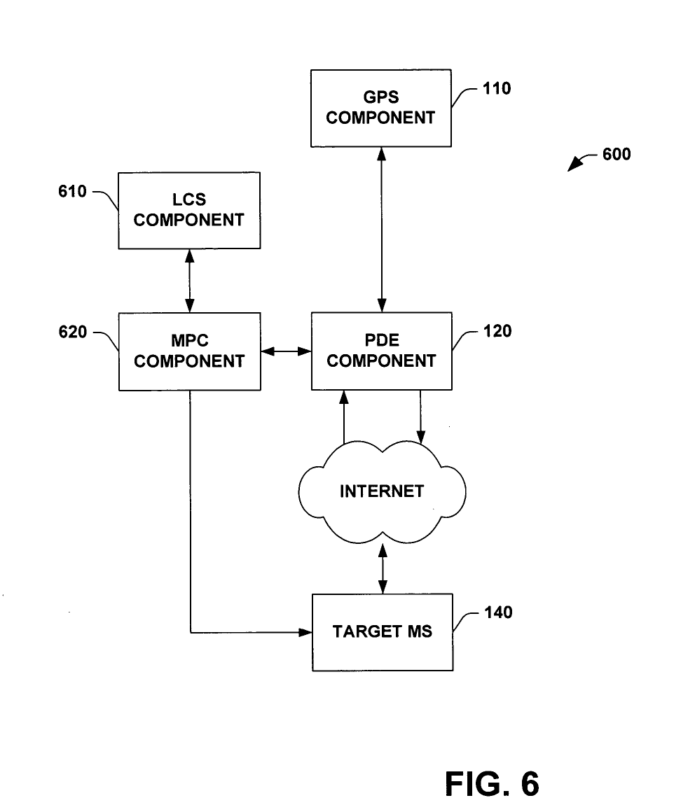

Turning to FIG. 6, a system 600 utilizes a location service (LCS) component 610 and a mobile positioning center (MPC) component 620 in which the location of mobile station 140 can be communicated. The MPC component 620 receives information from the PDE component 120. Thus, the PDE information including, for example, address of a PDE, can be communicated to the MPC component 620. Once the PDE information is transmitted to the MPC component, the PDE information can be sent to the mobile station 140. The PDE information provides the mobile station 140 to communicate with a PDE. With the location determination session employing location assistance, the LCS component can receive information which provides the location of the mobile station 140.

In one aspect in accordance with the present invention, the LCS component 610 provides for initiation of the system 600. For example, the system 600 can provide a user with the location of a lost and/or stolen mobile station 140. To initiate, the LCS component 610 sends a request to the MPC component. The MPC component 620 communicates the request to the PDE component. It is to be appreciated the MPC and PDE interface can be different from the LCS component and MPC interface, in which the proper communication sequence would allow the request to be communicated. Once the PDE component 120 determines the PDE that would assist for location determination locating services, a PDE message is created. The PDE information message enables the mobile station 140 to identify the PDE for location determination communications. The MPC component receives the PDE information message and sends it to the mobile station 140 to employ the IP-based location determination locating service. Utilizing the location determination session, the LCS component can inform the user of the lost and/or stolen mobile station 140.

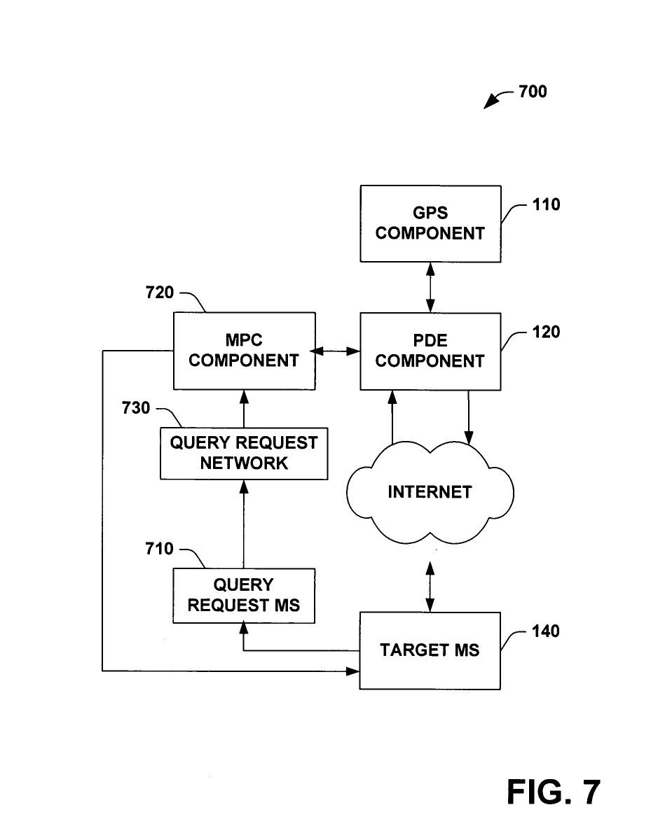

Turning to FIG. 7, a system 700 provides the mobile station 140 to initiate a location determination location service via Internet protocols. The query request MS 710 communicates with a query request network 730 to provide a mobile station 140 employment of the locating system. The query request MS 710 creates the request which can contain, for example, details of desired location information, transaction rate, and/or authentication data. In accordance to one aspect of the present invention, the desired location information can be position quality of service (PQoS). Another aspect of the present invention provides the authentication data asserting the mobile station identity to th query request network 730 in the network (e.g., WAP proxy or home MPC). In yet another aspect in accordance with the present invention, the request provides the identity of server providing the location-based application. Thus, the system 700 provides keeping records for user activity and the location determination locating system. For example, a network operator can utilize the system 700 in order to determine the statistics for location service.

In addition to creating the query, the query request MS 710 sends the query to the query request network 730. 7In one aspect of the present invention, the query request MS 710 sends the query to a well-known and trusted network entity. For example, a WAP proxy configured for receiving such a query can be used. In order to utilize the WAP proxy, the query request component 710 can employ HTTP methods, for example HTTP POST method. In another aspect in accordance with the present invention, the HTTP message can be sent to a well-known and pre-configured uniform resource identifier (URI). In yet another aspect in accordance with the present invention, the well-known and trusted network entity can be the address of the home MPC.

Furthermore, the query request component 710 communicates the query request to the MPC component 720. The MPC component 720 forwards the request to the PDE component 120. The MPC component 720 also receives the PDE information message, which is transmitted to the mobile station 140 to facilitate the identification of a PDE for location determination communication via Internet protocol.

For example, the terminal-initiated location service system 700 can utilize a location-based application such as, but not limited to, a restaurant locator application to determine the location of a restaurant in reference to user and mobile station 140. A user can initiate the restaurant application through the mobile station 140. The mobile station 140 can send a query through the query request component 710 to the MPC component 720 in order to discover the PDE component 120 which would assist for location determination to determine the mobile station's location. The MPC component 720 can create the PDE information message to be sent to the mobile station 140. When the mobile station 140 receives the PDE information message, the location determination session is initiated via Internet protocols. The mobile station 140 can then perform location determination transactions in order to determine the location of itself.

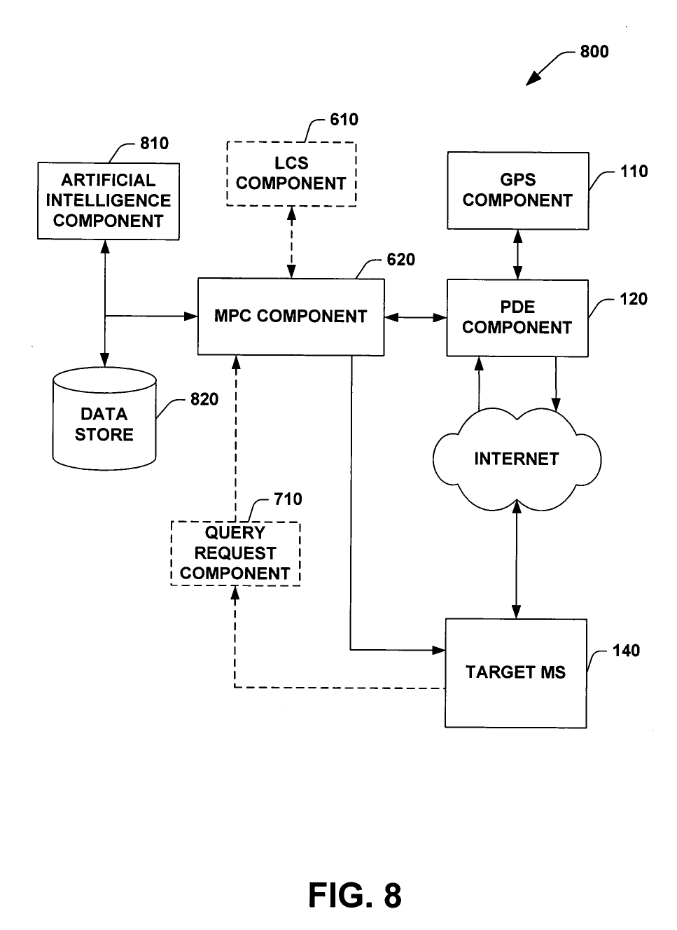

Referring to FIG. 8, a system 800 utilizes an artificial intelligence component 810 and data store 820. The artificial intelligence component 810 can utilize artificial intelligence techniques to infer which PDE component 120 can assist the mobile station 140 in an A-GPS most appropriately. For example, the artificial intelligence component 810 can perform the inference based at least in part upon a user profile. The user profile can include information such as, but not limited to, service plan, type of mobile station 140, home address, type(s) of location-based application, and/or historic information regarding location.

The data store 820 facilitates storage of applications and parameter interrogation questions. For example, the data store 820 can be computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the present invention. In one example, the data store 820 can store user profile(s). By employing user profile, efficiency of location-based applications can be optimized. In another example, the data store 820 can store location-based applications for a user to utilize via the mobile station 840.

In one aspect in accordance to the present invention, the system 800 can utilize an artificial intelligence technique (e.g., Bayesian learning methods that perform analysis over alternative dependent structures and apply a score, Bayesian classifiers and other statistical classifiers, including decision tree learning methods, support vector machines, linear and non-linear regression and/or neural network representation). For example, the artificial intelligence technique can infer to utilize a UDP port based at least in part upon the necessity of speed over reliability for the location-based application. In another example, the artificial intelligence technique can infer to utilize a TCP port for the location determination session based at least in part upon a user necessity of reliability over speed for the location-based application.

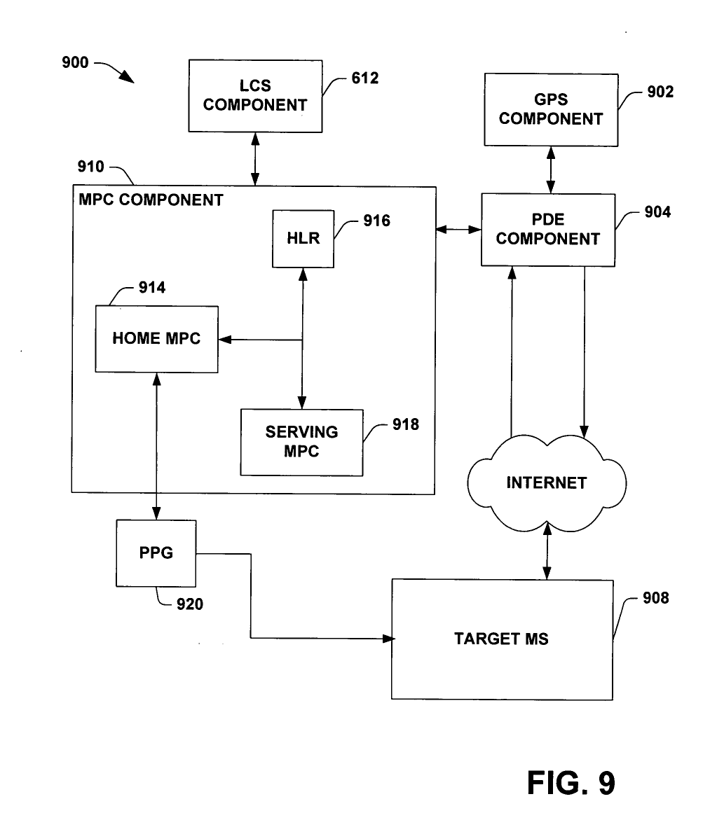

Now referring to FIG. 9, a detailed discussion of a WAP Push architecture is discussed in accordance with a system 900 of one embodiment of the subject invention. An MPC component 910 utilizes the WAP Push architecture for network-initiated location service. Unlike the traditional pull model for content fetching in client-server architecture (e.g. WWW) wherein client initiates the request for content and server responds with content; a push model enables asynchronous (without client explicitly initiating a request for it) sending of content from server to client. The pushing of content within the WAP architecture can be achieved via short messaging service (SMS) which allows short messages (e.g., up to 160 octets) to be sent or received. The WAP Push architecture utilizes a component that generates and sends the content called a push initiator. The push initiator can be, for example, home MPC. The content of the push message is formatted based upon a Push Access Protocol (PAP) interface. The push initiator (e.g., the home MPC) communicates with the Push Proxy Gateway (PPG) through the PAP over HTTP or SMTP (Simple Mail Transfer Protocol). The PAP receives from the push initiator a multipart submission consisting of a control entity, a content entity, and a capabilities entity. The control entity can be formatted in XML in which details of the delivery are given. For example, the content entity provides PDE component information. The push recipient can be a WAP and/or SMS enabled device (e.g., mobile station 908).

The MPC component 910 comprises a home MPC 914, a Home Location Register (HLR) 916, a serving MPC 918, and a Push Proxy Gateway (PPG) 920. The MPC component 910 receives network request for locating a mobile station 908, determines the PDE component 904 which can assist the mobile station 908 in a location determination session, and sends PDE information message to the mobile station 908. The serving MPC 918 is an MPC in the visited network of the mobile station 908. The home MPC forwards the request to serving MPC. For this, the home MPC consults HLR to find out current point of attachment of the mobile station and the associated serving MPC. The serving MPC 918 provides the PDE information to the home MPC 914. The home MPC 914 is an MPC in the home network of the mobile station 908 and provides access to the HLR 916. The HLR 916 is a database within the user's home network containing information such as, but not limited to, subscription information, information about user's current point of attachment to the network, and other preferences. The user's current point of attachment to the network can be obtained, for example, via registration procedure wherein the mobile station 908 notifies the HLR 916 whenever it changes its point of attachment to the network as a result of user mobility. The HLR 916 can also include an Access Control List (ACL). The ACL can be a specific list of LCS component (e.g., LCS clients) that determines who is allowed to obtain the mobile station 908 location.

The PPG 920 receives the PDE information from the home MPC 914 and pushes it to the mobile station 908. In accordance with an aspect of the present invention, the PPG 920 can employ connectionless push via short messaging service (SMS) in WAP Push Architecture. The SMS is sent to the mobile station 908 having the PDE information. The PPG 920 ensures security of the push by not allowing other entities than trusted MPCs to initiate such push. The mobile station does not accept push message containing PDE information from entities other than trusted PPG. In addition, SMSC (SMC Center) that is responsible for delivering incoming SMS messages to the mobile station 908 does not allow messages to be delivered unless submitted by a trusted entity.

In yet another aspect in accordance with the present invention, the PPG 920 can utilize a connection-oriented push as specified in WAP Push architecture. For example, the session initiation request (SIR) is sent to the mobile station 908 using SMS. SIR is forwarded to session initiation application (SIA) in the mobile station 908. The SIA establishes a session (e.g., HTTP/TCP/IP or WSP (Wireless Session Protocol)) with PPG 920 and retrieves the push message with the PDE information.

In another aspect in accordance to the present invention, the home MPC 914 can add identity of the location-based application interested in the location of the mobile station 908 to the pushed information message. The identity of the location-based application can be used to prompt the user for location service consent. Furthermore, the MPC can provide an identity message with the home MPC information as a contact point for any diagnostic data (e.g., error condition). For example, the mobile station 908 can identify the message from the PPG 920 with a well-known “Application-ID” value. Once the mobile station 908 receives the pushed message with the “Application-ID” and containing the PDE information, an IP-based port can initiate a location determination session with PDE for location determination.

For example, upon network-initiated location service, the serving MPC 918 can determine the associated PDE in which location determination would be assisted. The serving MPC 918 gives the PDE information to the home MPC 914. Utilizing the HLR 916, the home MPC 914 locates the mobile station 908. The PPG 920 receives the PDE information message and pushes the message (e.g., SMS message) with PDE information to the mobile station 908. The mobile station 908 can identify the SMS message based at least in part upon the “Application-ID.” Upon verification, the mobile station 908 initiates location determination session via IP-based port. In one aspect in accordance with the present invention, the mobile station 908 prompts the user for consent to provide location information. Upon approval or denial, a report is sent to the home MPC 914.

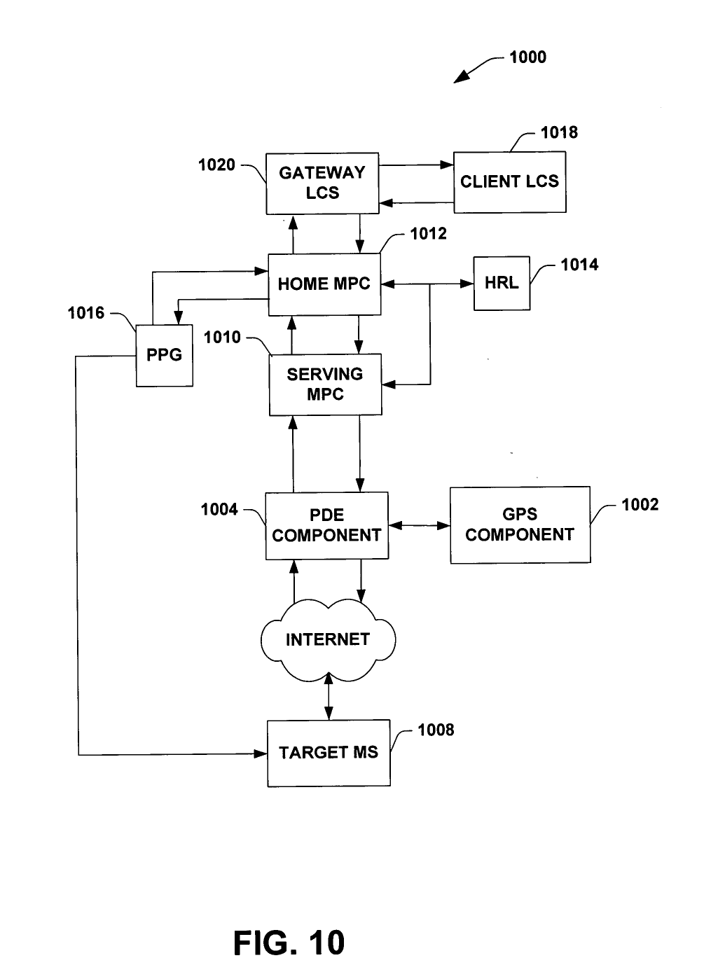

Now turning to FIG. 10, a network-initiated location service system 1000 includes a GPS component 1002, a PDE component 1004, a mobile station 1008, a serving MPC 1010, a home MPC 1012, a HLR 1014, a PPG 1016, a client LCS 1018, and a gateway LCS 1020. The network-initiated location service system 1000 provides an IP-based port to initiate a location determination session within a CDMA network.

A client LCS 1018 provides for making a request for mobile station location service. The client 1018 interfaces with a gateway LCS 1020 for communication. For example, the client LCS and gateway LCS communications can be based upon a mobile location protocol (MLP) specified by a location interoperability forum (LIF). In one aspect in accordance to the present invention, the MLP can be implemented over HTP/TCP/IP. Upon a client LCS initiation, the gateway LCS 1020 routes the network-initiated request to the home MPC 1012. The home MPC 1012 is in the home network of the mobile station 1008. The home MPC 1010 provides access to the HLR 1014. The HLR 1014 is a database within the user's home network containing information such as, but not limited to, subscription information, information about user's current point of attachment to the network, and other preferences. The user's current point of attachment to the network can be obtained, for example, via registration procedure wherein the mobile station 1008 notifies the HLR 1014 whenever it changes its point of attachment to the network as a result of user mobility. The HLR can also provide home MPC with the identity of serving MPC. The home MPC 1012 forwards the request to a serving MPC 1010. The serving MPC 1010 is an MPC in the visited network of the mobile station 1008. The serving MPC 1010 provides the PDE information to the home MPC 1012. Based at least in part upon the information in the HLR 1014, the home MPC 1012 sends the PDE information to the PPG. The PPG 1016 pushes the PDE information to the mobile station 1008.

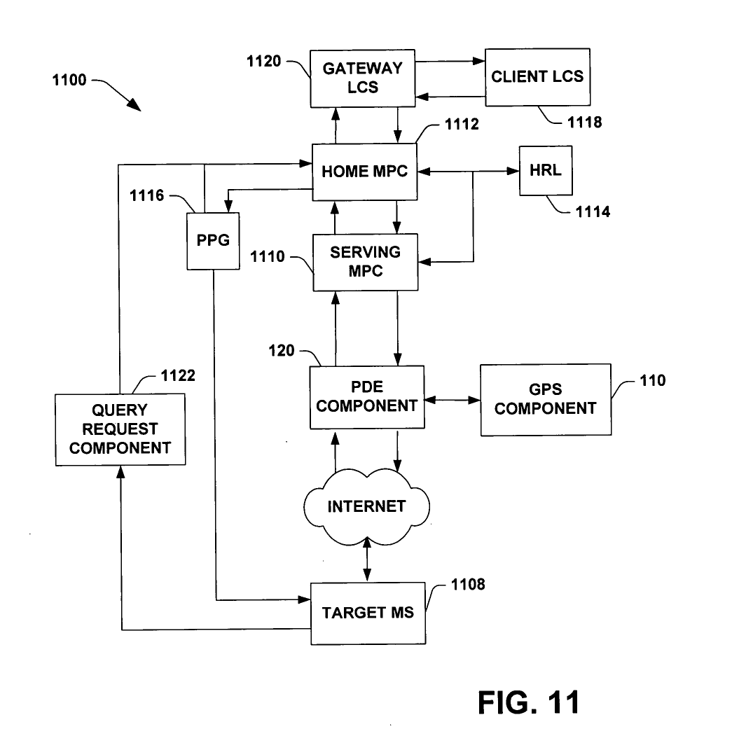

Turning to FIG. 11, a terminal-initiated location service system 100 provides to initiate location determination session within a CDMA network using IP. A mobile station 1108 sends a query request for location service via a query request component 1122. The query request component 1122 creates a query with, for example, the desired location information. A home MPC 1112 receives the query request—the home MPC 1112 is in the home network of the mobile station 1108. The home MPC 1110 provides access to an HLR 1114, which is a database within the user's home network storing information such as, but not limited to, subscription information, information about user's current point of attachment to the network, and other preferences. The user's current point of attachment to the network can be obtained, for example, via registration procedure wherein the mobile station 1108 notifies the HLR 1114 whenever it changes its point of attachment to the network as a result of user mobility. Based at least in part upon the information in the HLR 1114, the home MPC 1112 determines the identity of serving MPC 1110. The home MPC 1112 forwards the request to a serving MPC 1110. The serving MPC 1110 is an MPC in the visited network of the mobile station 1108. The serving MPC 1110 provides the PDE information to the home MPC 1112. Once a location determination session is initiated by an Internet protocol, the location determination can begin. The location of the mobile station 1108 can be utilized by the client LCS 1118.

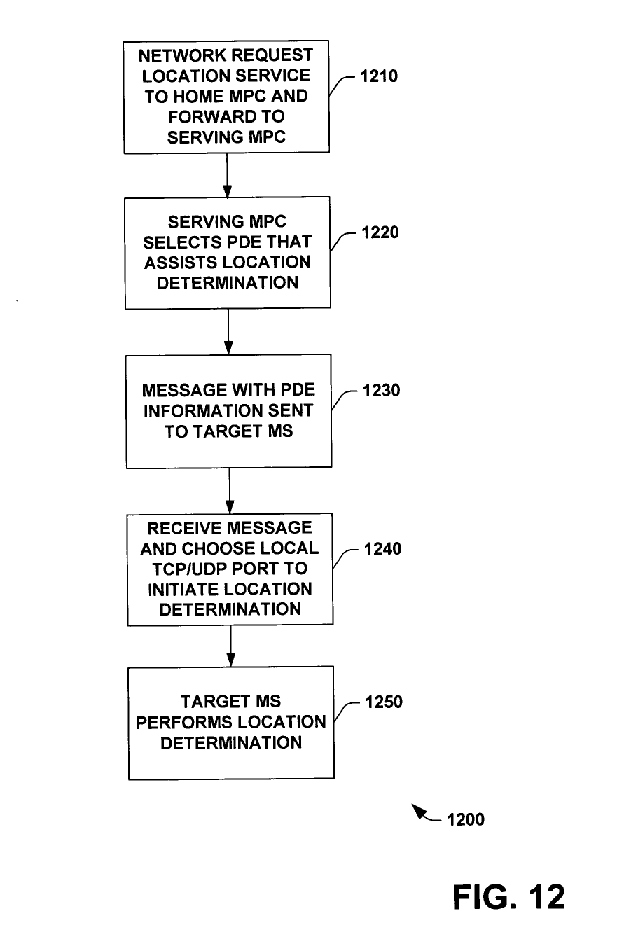

FIGS. 12-14 illustrate various methodologies in accordance with the subject invention. While, for purposes of simplicity of explanation, the methodologies are shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

FIG. 12 is a methodology 1200 for a network-initiated location service in connection with the subject invention. At 1210, the home MPC receives a network request for location service. The home MPC locates the serving MPC based upon an HLR query and then forwards the request to the serving MPC. At 1220, the serving MPC selects the PDE which would assist the mobile station for location service via, for example, A-GPS. At 1230, a message with the PDE information is sent to the mobile station. For example, the serving MPC can find the PDE information and forward it to the home MPC. The home MPC can send the PDE information message. In one example, the PDE message is sent utilizing WAP Push architecture, either using connectionless or connection-oriented push method. At 1240, the message is received by the mobile station in which an Internet protocol is used to initiate the location determination session. At 1250, the mobile station performs the location determination transactions allowing for location determination in which the LCS client can be communicated the location of the target MS by the home MPC and a gateway.

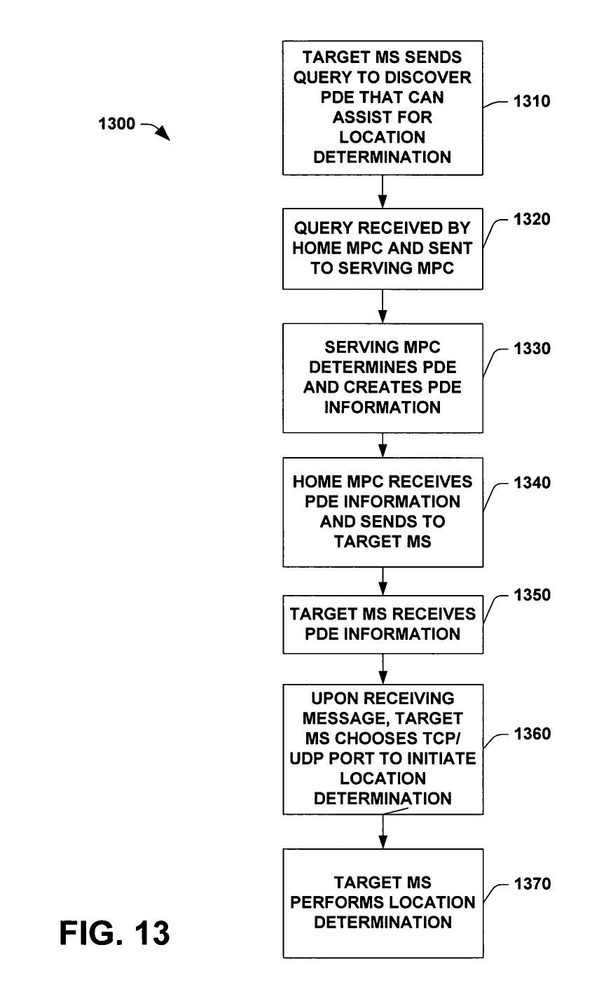

FIG. 13 is a methodology 1300 for a terminal-initiated location service. At 1310, a mobile station sends a query request to discover a PDE that will assist for location determination positioning. At 1320, the query is received by the home MPC and forwarded to the serving MPC. At 1330, the serving MPC determines the PDE that can provide location determination assistance and creates PDE information. At 1340, the PDE information is sent to the home MPC and then to the mobile station. For example, the PDE information can be sent as response to query. At 1350, the PDE information is received by the mobile station and the mobile station chooses an Internet protocol port to initiate the location determination session. At 1360, the mobile station performs location determination transactions allowing for location service.

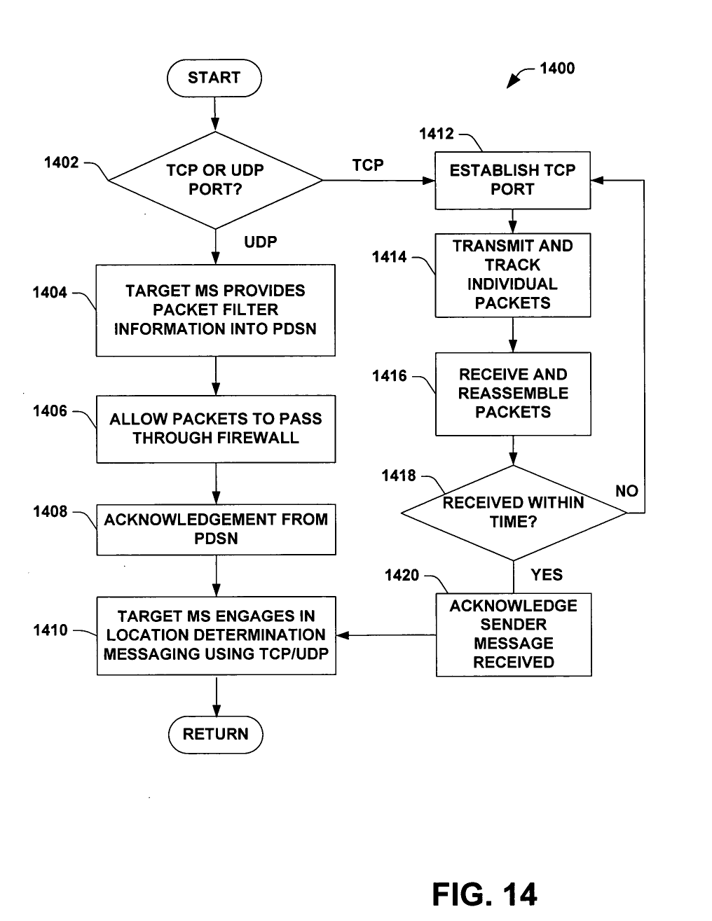

Turning to FIG. 14, a methodology 1400 for Internet protocol location determination initiation is shown. At 1402, the PDE information message analyzed whether a TCP port or a UDP port is specified. If a UDP port is specified within the PDE information message, the mobile station provides packet filter information into PDSN at 1404. For example, the packet filter information (e.g., Traffic Flow Template or TFT) can be, but not limited to, IP address and UDP port number, PDE's IP address and UDP port number. At 1406, the PDSN is instructed to allow the packets satisfying the parameter values in their headers to pass through the firewall. At 1408, the PDSN sends acknowledgement. At 1410, the mobile station engages in location determination messaging with the prescribed PDE using either TCP or UDP (UDP in this case).

If a TCP port is specified within the PDE information message, the mobile station provides establishing a TCP port at 1412. At 1414, the TCP port transmits and tracks the individual packets. AT 1416, the port receives and reassembles the packets. At 1418, the methodology ensures all packets are sent and received within a timely manner. If the packets are all received, the TCP port acknowledges the sender that all packets are received at 1420. If the packets are not received in a timely manner, the port will retry the transmission at 1414. Once the packets are received, the mobile station engages in location determination messaging using a TCP or UDP port.

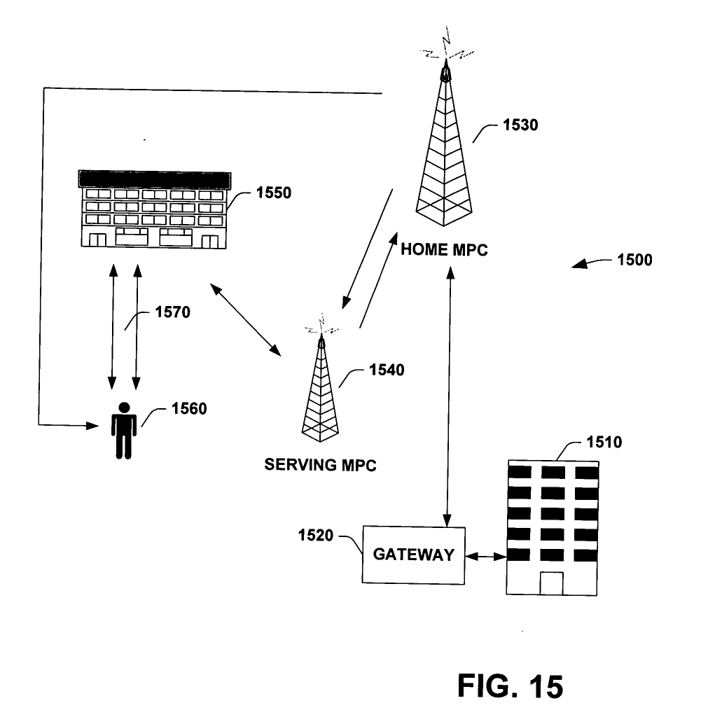

Referring to FIG. 15, a network-initiated location service 1500 in accordance with the present invention is depicted. The LCS client 1510 (e.g., network) initiates the location service request. The request is transmitted via a gateway 1520. The gateway 1520 provides LCS client 1510 interaction with a wireless network (e.g., gateway can be a server box connected to the Internet). The gateway 1520 communicates the LCS client 1510 request to a home MPC 1530. The home MPC 1530 locates the serving MPC 1540 and communicates with the serving MPC 1540 to determine the PDE 1550 that would assist the user and mobile station 1560. The serving MPC 1540 creates a PDE information message and sends the PDE information to the home MPC in which the home MPC sends PDE information to mobile station 1560. Upon receiving the PDE information message, mobile station 1560 initiates location determination session 1570. The session 1570 is Internet Protocol based. The PDE information message provides the PDE information necessary to transmit location determination assistance data and position information for location service.

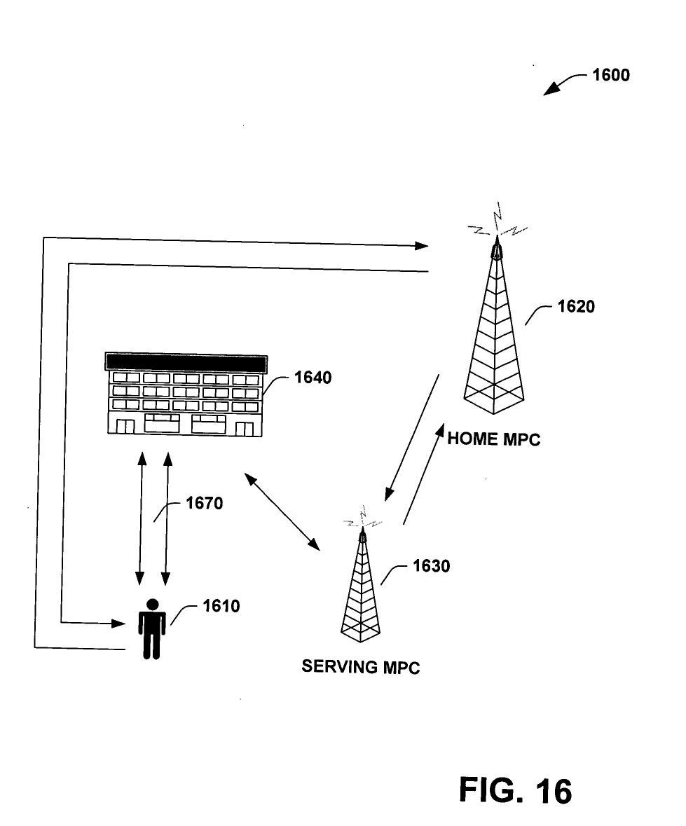

Referring to FIG. 16, a terminal-initiated location service 1600 in accordance with the present invention is depicted. The user and mobile station 1610 initiate the location service. The mobile station 1610 sends a query request to a home MPC 1620. The home MPC communicates the request to the serving MPC 1630. The serving MPC determines the PDE 1640 in which location determination assistance would be provided. The home MPC creates a PDE information message from the serving MPC forwarded information. The home MPC then sends the PDE information to the user and target MS 1610. Upon receiving the PDE information message, target MS and user 1610 initiates location determination session 1670. The location determination session 1670 is Internet Protocol based. The PDE information message provides the PDE information necessary to transmit location determination assistance data and position information for location service. The target MS and user 1610 directly access location-based application(s) over the Internet (e.g., there is no gateway required). via

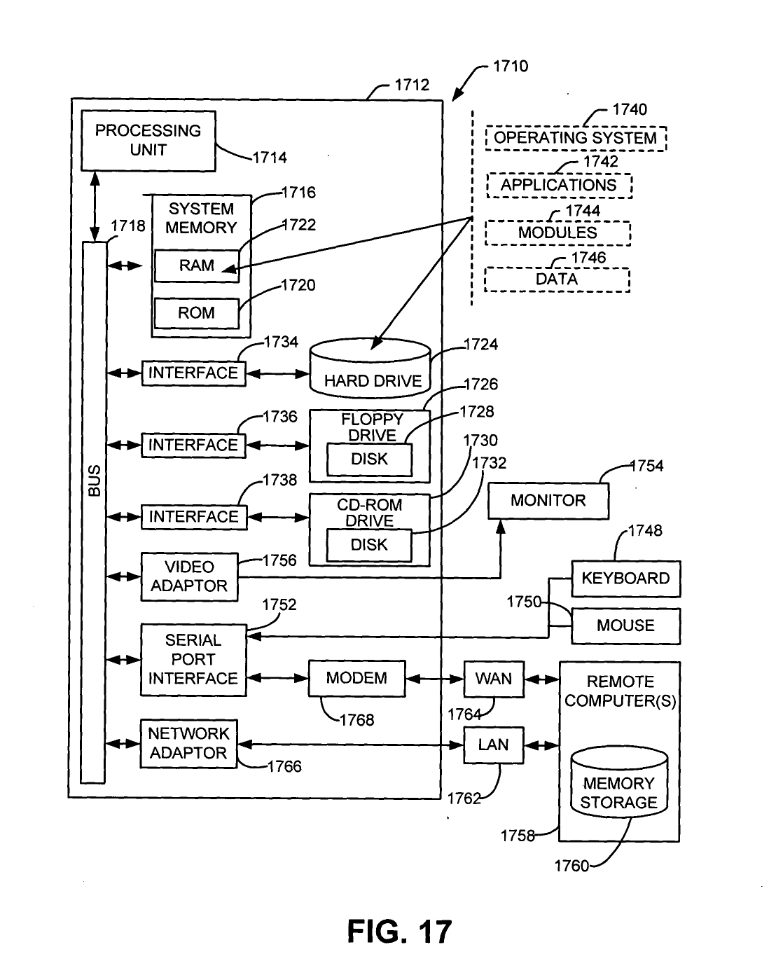

In order to provide additional context for various aspects of the present invention, FIG. 17 and the following discussion are intended to provide a brief, general description of a suitable operating environment 1710 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software. Generally, however, program modules include routines, programs, objects, components, data structures, etc. that perform particular tasks or implement particular data types. The operating environment 1710 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 17, an exemplary environment 1710 for implementing various aspects of the invention includes a computer 1712. The computer 1712 includes a processing unit 1714, a system memory 1716, and a system bus 1718. The system bus 1718 couples system components including, but not limited to, the system memory 1716 to the processing unit 1714. The processing unit 1714 can be any of various available processors. Dual microprocessors and other multiprocessor architectures also can be employed as the processing unit 1714.

The system bus 1718 can be any of several types of bus structure(s) including the memory bus or memory controller, a peripheral bus or external bus, and/or a local bus using any variety of available bus architectures including, but not limited to, 14-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1716 includes volatile memory 1720 and nonvolatile memory 1722. The basic input/output system (BIOS), containing the basic routines to transfer information between elements within the computer 1712, such as during start-up, is stored in nonvolatile memory 1722. By way of illustration, and not limitation, nonvolatile memory 1722 can include read only memory (ROM), programmable ROM (PROM), electrically programmable ROM (EPROM), electrically erasable ROM (EEPROM), or flash memory. Volatile memory 1720 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1712 also includes removable/nonremovable, volatile/nonvolatile computer storage media. FIG. 17 illustrates, for example a disk storage 1724. Disk storage 1724 includes, but is not limited to, devices like a magnetic disk drive, floppy disk drive, tape drive, Jaz drive, Zip drive, LS-100 drive, flash memory card, or memory stick. In addition, disk storage 1724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1724 to the system bus 1718, a removable or non-removable interface is typically used such as interface 1726.

It is to be appreciated that FIG. 17 describes software that acts as an intermediary between users and the basic computer resources described in suitable operating environment 1710. Such software includes an operating system 1728. Operating system 1728, which can be stored on disk storage 1724, acts to control and allocate resources of the computer system 1712. System applications 1730 take advantage of the management of resources by operating system 1728 through program modules 1732 and program data 1734 stored either in system memory 1716 or on disk storage 1724. It is to be appreciated that the present invention can be implemented with various operating systems or combinations of operating systems.

A user enters commands or information into the computer 1712 through input device(s) 1736. Input devices 1736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1714 through the system bus 1718 via interface port(s) 1738. Interface port(s) 1738 include, for example, a serial port, a parallel port, a game port, and a universal serial bus (USB). Output device(s) 1740 use some of the same type of ports as input device(s) 1736. Thus, for example, a USB port may be used to provide input to computer 1712, and to output information from computer 1712 to an output device 1740. Output adapter 1742 is provided to illustrate that there are some output devices 1740 like monitors, speakers, and printers among other output devices 1740 that require special adapters. The output adapters 1742 include, by way of illustration and not limitation, video and sound cards that provide a means of connection between the output device 1740 and the system bus 1718. It should be noted that other devices and/or systems of devices provide both input and output capabilities such as remote computer(s) 1744.

Computer 1712 can operate in a networked environment using logical connections to one or more remote computers, such as remote computer(s) 1744. The remote computer(s) 1744 can be a personal computer, a server, a router, a network PC, a workstation, a microprocessor based appliance, a peer device or other common network node and the like, and typically includes many or all of the elements described relative to computer 1712. For purposes of brevity, only a memory storage device 1746 is illustrated with remote computer(s) 1744. Remote computer(s) 1744 is logically connected to computer 1712 through a network interface 1748 and then physically connected via communication connection 1750. Network interface 1748 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1750 refers to the hardware/software employed to connect the network interface 1748 to the bus 1718. While communication connection 1750 is shown for illustrative clarity inside computer 1712, it can also be external to computer 1712. The hardware/software necessary for connection to the network interface 1748 includes, for exemplary purposes only, internal and external technologies such as, modems including regular telephone grade modems, cable modems and DSL modems, ISDN adapters, and Ethernet cards.

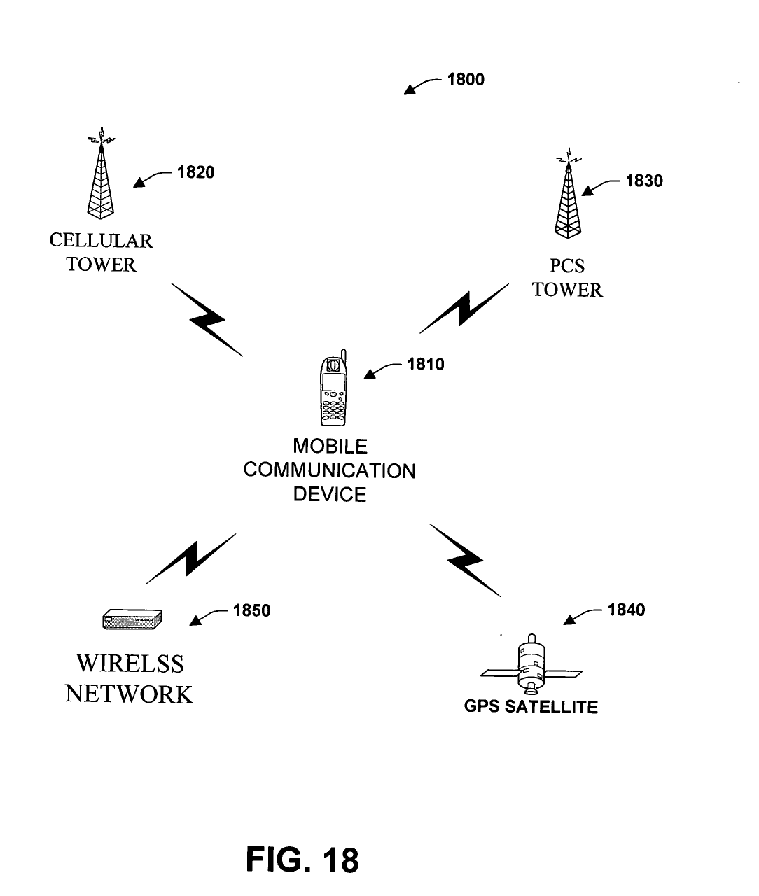

Proceeding to FIG. 18, an exemplary mobile communications environment (“environment”) 1800 is illustrated in accordance with an aspect of the present invention. The environment 1800 comprises a mobile communication device (“device”) 1810, a cellular transceiver 1820, a PCS transceiver 1830, a GPS transceiver 1840 and a wireless network 1850.

The device 1810 can be similar to the systems and components described herein and/or can include the aforementioned systems and components. For example, the device 1810 can comprise a dualband CDMA antenna, a GPS antenna, a Bluetooth antenna, and other components such as a firewall, a processing component and a reflector. In addition, enhanced and other transmission technologies (e.g., CDMA2000, WCDMA and TD-SCDMA) and other various other antenna configurations, as described supra, can be utilized in accordance with an aspect of the invention.

The device 1810 can employ its various mobile communication technologies to communicate with the cellular transceiver 1820, the PCS transceiver 1830, the GPS transceiver 1840 and the wireless network 1850. For example, the device 1810 can transmit cellular information to and/or receiver cellular information from the cellular transceiver 1820. Likewise, the device can transmit and/or receive information with the wireless network 1850, for example with one or more devices employing Bluetooth technology such as a PDA, a printer, a copier, a facsimile, a scanner, a display, a computer, a microprocessor and/or another mobile communication device similar to the device 1810.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that facilitates determining location of mobile stations, comprising:
a mobile station that receives information regarding a position determining entity (PDE), and opens an user datagram protocol (UDP) session to establish a location determination session with the PDE.

2. The system of claim 1, further comprising a mobile positioning center (MPC) that generates a message including the information regarding an optimal PDE that can assist the mobile station in the location determination session.

3. The system of claim 2, further comprising a component that stores historical IP messages regarding locating the optimal PDE.

4. The system of claim 1, the message containing information regarding PDE comprising at least one of: IP address of the PDE, transport protocol communication method of the PDE, transport protocol port number, and session lifetime of the PDE, temporary session ID, secure message exchange key.

5. The system of claim 2, the MPC providing the message via connectionless or connection oriented push.

6. The system of claim 1, the mobile station establishing the location determination session via the IP session in lieu of employment of a signal system 7 (SS7) network.

7. The system of claim 2, the mobile station initiating a query for the PDE information.

8. The system of claim 7 further comprising a data store that stores historical database information regarding the query.

9. The system of claim 7, the query is an HTTP POST.

10. The system of claim 2, the message is in XML format.

11. The system of claim 2, further comprising an artificial intelligence (AI) component to facilitate identifying the optimal PDE.

12. The system of claim 11, the AI component comprising a trained classifier.

13. The system of claim 1, the mobile station is a cellular telephone.

14. The system of claim 1, the mobile station is a portable computer.

15. The system of claim 13, the cellular telephone containing a GPS component.

16. The system of claim 1, further comprising a component that opens a TCP session in lieu of the UDP session based on reliability versus setup latency cost-benefit analysis.

17. The system of claim 1, the mobile station sending a traffic flow template to a packet data support node to open a firewall.

18. The system of claim 1, further comprising an application that requests other mobile station location updates via terminal initiated procedures.

19. The system of claim 1, the location determination session is initiated by the mobile station.

20. The system of claim 1, the location determination session is initiated by a network entity other than the mobile station.

21. The location determination session of claim 18 utilizing third party IP-based location services.

22. The system of claim 1, the location determination session initiated by a user interface residing in the mobile station.

23. The system of claim 21, the user interface is a J2ME application.

24. A mobile positioning methodology comprising:
determining a network attachment point of a mobile station; and
employing a home mobile positioning center (MPC) to request a serving MPC to provide position determining entity (PDE) information regarding a location determining service to facilitate the mobile station opening a suitable location determination session.

25. The method of claim 24, further comprising employing a home location register to provide the network attachment point for the mobile station.

26. The methodology of claim 25, the network attachment location being in a home network.

27. The methodology of claim 24, the network attachment location being in a visiting network.

28. The method of claim 24, further comprising discovering available PDEs.

29. A system that facilitates determining location of mobile stations, comprising:
means for determining a most suitable internet protocol (IP) of a plurality of internet protocols to employ for a session between a mobile station and a position determining entity (PDE); and
means for establishing the session.

30. The system of claim 29, further comprising means for establishing an assisted global positioning system (AGPS) session with the PDE.

31. A computer-implemented method that facilitates determining location of a mobile station comprising:
receiving information regarding a position determining entity (PDE);
employing the PDE information to establish a user datagram protocol session between a cellular telephone and the PDE; and
employing an assisted global positioning system (A-GPS) to determine approximate location of the cellular telephone.

32. The method of claim 31 further receiving queries from the cellular telephone regarding identifying an optimal PDE.

33. The method of claim 32 further comprising tracking the queries.

34. A computer readable medium having stored thereon computer executable instructions for performing the method of claim 31.

35. A mobile positioning center (MPC) that facilitates identifying location of a mobile station, comprising:
a component that receives a request from the mobile station for identification of a position determining entity (PDE);
a component that provides the mobile station with information regarding the PDE, the information including data to facilitate establishing a user datagram protocol session with the PDE.

36. A method that facilitates location determination of a mobile station, comprising:
sending via an HTTP POST over TCP/IP a discovery request for a location of a mobile station; and
sending to the mobile station via HTTP position determining entity information.

37. The method of claim 36, further comprising employing an authentication protocol.

38. The method of claim 36, the authentication protocol comprising at least one of: Kerberos, public keys, trusted certificates, internet key exchange (IKE), internet protocol security (IPS), and secure socket layers (SSL).
